(19) United States
(12) Patent Application Publication
(10) Pub. No.: US 2017/0189249 A1
(43) Pub. Date: Jul. 6, 2017

(54) WHEELCHAIR CONTROL SYSTEM AND CONTROL METHOD USING THE SAME

(71) Applicant: ETI CA BATTERY INC., NEW TAIPEI CITY (TW)

(72) Inventor: WEI-CHEN WU, NEW TAIPEI CITY (TW)

(21) Appl. No.: 15/060,638

(22) Filed: Mar. 4, 2016

(30) Foreign Application Priority Data
Jan. 5, 2016 (TW) 105100133

(51) Int. Cl. A61G 5/04

(52) U.S. Cl. CPC A61G 5/04; A61G 2005/1051

(57) ABSTRACT

A wheelchair control system and a control method using the same is provided. Firstly, providing a wheelchair which has a back provided with a first sensor and at least one second sensor arranged above the first sensor. The first sensor and the second sensor are electrically connected with a control device. A sitter sits in the wheelchair to trigger the first sensor and the second sensor, whereby the control device controls the wheelchair to operate. When the first sensor and the second sensor are triggered or non-triggered, the control device controls the wheelchair to stop or operate. The present invention controls the wheelchair to operate by changing the posture of the sitter, improves the conventional wheelchair to move by another person, and provides an automatic wheelchair for a sitter with upper limbs that inconveniently move. The sitter only moves his back to control the wheelchair to operate.

This application claims priority for Taiwan patent application no. 105100133 filed on Jan. 5, 2016, the content of which is incorporated in its entirely.

### BACKGROUND OF THE INVENTION

Field of the Invention

The present invention relates to a system for controlling a wheelchair to operate and a control method using the same, particularly to a wheelchair control system controlling a wheelchair to operate by changing a posture of a sitter and a method using the same.

Description of the Related Art

Earlier designs of wheelchairs are suited to sitters with lower disabled limbs or disabled sitters and provided to the sitters for sitting and conveniently moving. A wheelchair is moved by another person and in addition to that a sitter himself can rotate rims of the wheelchair to move the wheelchair. Gradually, the conventional wheelchairs are inconvenient for many sitters. For example, a sitter with upper disabled limbs cannot move the wheelchair. Thus, another person has to help the sitter move the wheelchair. In other words, the wheelchair is not used as an assistive device moved by the sitter himself. As a result, various electric wheelchairs are invented later on to overcome the drawbacks of the conventional wheelchairs.

In general, an electric wheelchair is directly controlled by a sitter to greatly reduce the sitter's force. The sitter controls the wheelchair to move only with his hands. For example, the Taiwan Patent of No. 364844 disclosed a wheelchair which provides a manual wheel rim. Driven by a control motor, the manual wheel rim detects the magnitude of the force of a person. A sitter controls the manual wheel rim without too much force. Besides, the Taiwan Patent of No. 555554 disclosed a power-assisted wheelchair installed on a wheelchair whose wheel rims are provided with sensors. The sensors sense the force of hands of a sitter to control the wheelchair. Alternatively, the sitter controls the wheelchair with one hand. Although the abovementioned technologies improve the operation that the conventional technology uses a control rod to control an electric wheelchair to move forward or change moving directions, the abovementioned technologies all require one hand of the sitter to control the wheelchair. The conventional control rod further limits right or left hand of the sitter to control the wheelchair. Other conventional technologies also control the wheelchair with “hands”. The sitters with upper and lower disabled limbs still need others' help to move. As a result, the abovementioned technologies are still not perfect.

To overcome the abovementioned problems of the conventional technology and the electric wheelchair, the present invention provides a control system and a control method using the same, which control a wheelchair to operate without upper limbs whereby various sitters more conveniently move.

### SUMMARY OF THE INVENTION

A primary objective of the present invention is to provide a wheelchair control system and a control method of using the same, whereby the back of a sitter sitting in a wheelchair touches sensors in different ways, so as to control the wheelchair without “hands”. The system and the method are used for the broader population, and the system is optionally used as a self-movement assistive device, especially for sitters with upper disabled limbs.

Another objective of the present invention is to provide a wheelchair control system and a control method of using the same, whereby a sitter with upper disabled limbs or with able-bodied limbs uses an easily-controlled method to control a wheelchair to operate without complicated buttons or control activities, thereby achieving easy and convenient operation.

To achieve the abovementioned objectives, the present invention provides a wheelchair control system arranged on the back of a wheelchair. The wheelchair control system includes a first sensor, at least one second sensor and a control device. The first sensor is arranged on the back of the wheelchair. The second sensor is arranged on the back of the wheelchair and above the first sensor. The control device is electrically connected with the first sensor and the second sensor and controls the wheelchair to stop or operate according as the first sensor and the second sensor are triggered or non-triggered.

To achieve the abovementioned objectives, the present invention also provides a wheelchair control method, which includes steps of: providing a wheelchair with the back thereof provided with a first sensor and at least one second sensor arranged above the first sensor; a sitter sitting in the wheelchair; and the sitter controlling the wheelchair to stop or operate according as the first sensor and the second sensor are triggered or non-triggered.

The ways of controlling the wheelchair to operate includes: the first sensor and the second sensor are both triggered whereby the wheelchair stops; and the first sensor and the second sensor are both non-triggered whereby the wheelchair stops. The abovementioned wheelchair control method is easier for the sitter to control the wheelchair.

The first sensor further comprises at least two first sensing elements. When one first sensing element is triggered, the wheelchair moves in front-left or front-right directions. More detailed operation of the wheelchair is achieved by changing a position of touching the first sensor.

The second sensor is two or more second sensors, and the two second sensors are arranged on the back of the wheelchair from bottom to top. When the first sensor is triggered and the two second sensors are sequentially non-triggered, the wheelchair moves at different speed to perform another operation.

When the first sensor is triggered, the control device controls the wheelchair to move forward. A third sensor is arranged on the back of the wheelchair and above the second sensor and electrically connected with the control device. When the first sensor, the second sensor and the third sensor are all triggered, the control device controls the wheelchair to move backward. In addition to the front-left direction, the front-right direction and controlling speed, the operation of moving backward is provided when the wheelchair moves forward.

Below, the embodiments are described in detail in cooperation with the drawings to make easily understood the technical contents, characteristics and accomplishments of the present invention.

### BRIEF DESCRIPTION OF THE DRAWINGS

FIG. 1 is a front view of a wheelchair according to the first embodiment of the present invention;

FIG. 2 is a block diagram schematically showing a circuit of a control system according to the first embodiment of the present invention;

FIG. 3 is a front view of a sitter sitting in a wheelchair according to an embodiment of the present invention;

FIGS. 4a-4b are diagrams schematically showing stops of a wheelchair according to an embodiment of the present invention;

FIG. 5 is a diagram schematically showing a wheelchair moving forward according to an embodiment of the present invention;

FIG. 6a is a front view of a wheelchair according to the second embodiment of the present invention;

FIG. 6b is a diagram schematically showing a wheelchair moving in a front-right direction for a sitter according to an embodiment of the present invention;

FIG. 6c is a diagram schematically showing a wheelchair moving in a front-left direction for a sitter according to an embodiment of the present invention;

FIGS. 7a-7b are diagrams schematically showing acceleration of a wheelchair according to the third embodiment of the present invention;

FIG. 8 is a block diagram schematically showing a circuit of a control system according to the fourth embodiment of the present invention;

FIG. 9 is a diagram schematically showing operation of a wheelchair according to the fourth embodiment of the present invention;

FIG. 10 is a front view of a wheelchair according to the fifth embodiment of the present invention;

FIG. 11 is a block diagram schematically showing a circuit of a control system according to the fifth embodiment of the present invention;

FIG. 12 is a side view of a wheelchair according to the sixth embodiment of the present invention;

FIG. 13 is a block diagram schematically showing a circuit of a control system according to the sixth embodiment of the present invention; and

FIG. 14 is a flow chart showing a wheelchair control method according to an embodiment of the present invention.

### DETAILED DESCRIPTION OF THE INVENTION

The present invention can improve the drawbacks of the conventional wheelchairs or electric wheelchairs and provide a more humanistic operation interface and an easier operation way to a sitter of a wheelchair so that the sitter has different operation options. Besides, the present invention provides the best wheelchairs to sitters with disabled limbs or disabled sitters whereby the sitters control the wheelchair to operate without another person's help.

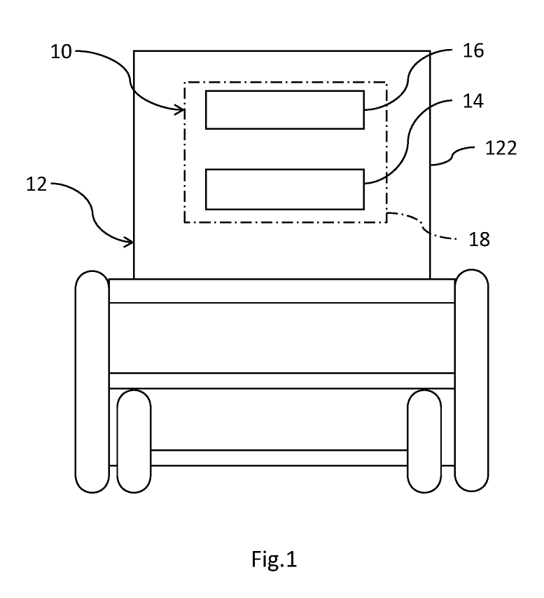

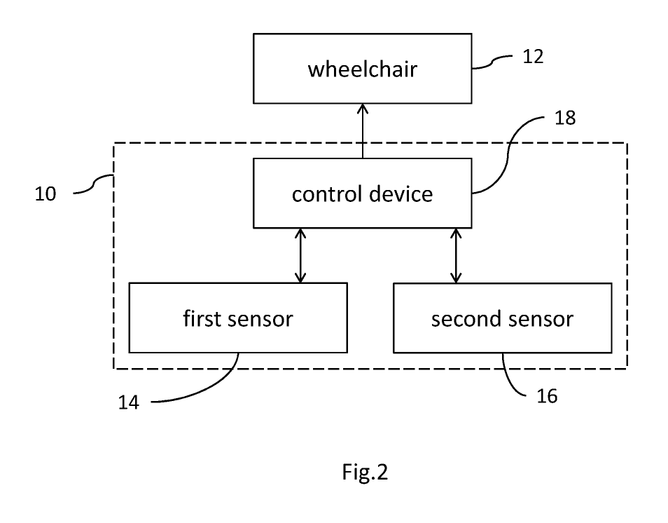

Firstly, refer to FIG. 1 and FIG. 2. A wheelchair control system 10 is arranged on the back 122 of a wheelchair 12. In the embodiment, the wheelchair 12 is an electric wheelchair. The wheelchair control system 10 comprises a first sensor 14 and at least one second sensor 16. In FIG. 1 of the embodiment, take one second sensor 16 for example. The amount and the shape of the second sensor 16 are not limited in the present invention. The amount of the second sensor 16 is two, three or more and changed according to the requirement of manufacturers. The wheelchair control system 10 further comprises a control device 18. The first sensor 14 and the second sensor 16 are arranged on the back 122 of the wheelchair 12. The second sensor 16 is arranged above the first sensor 14. When the amount of the second sensor 16 is larger than one, the second sensors 16 are arranged above the first sensor 14. The control device 18 (as shown by a dash line) is arranged in the back 122 of the wheelchair 12, which is used to explain the embodiment. The control device 18 is electrically connected with the first sensor 14 and the second sensor 16. The position of the control device 18 is not limited in the present invention and changed according to the requirement of manufacturers.

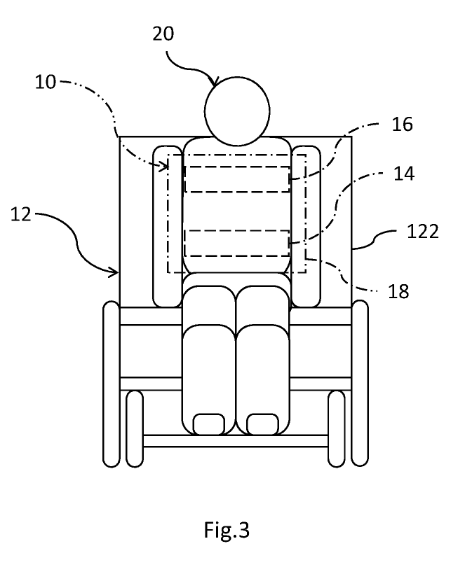

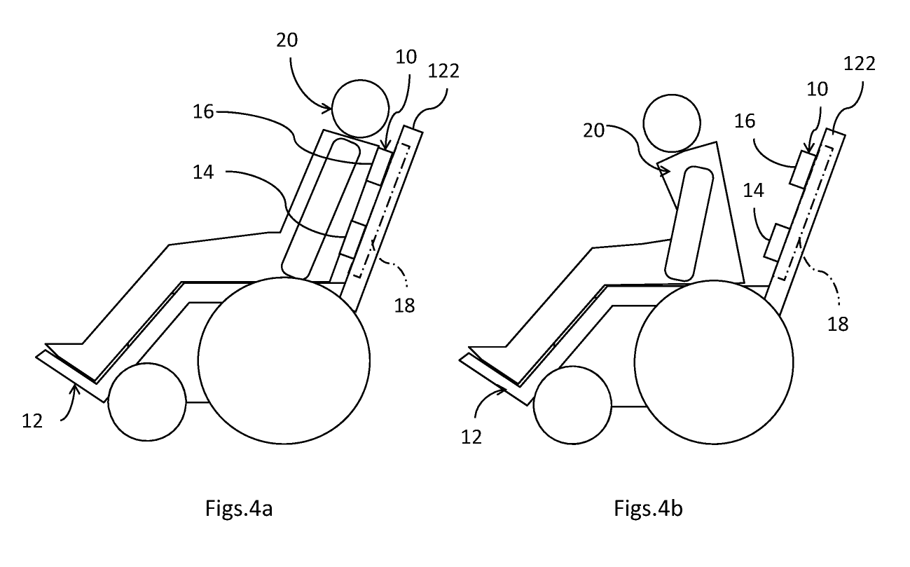

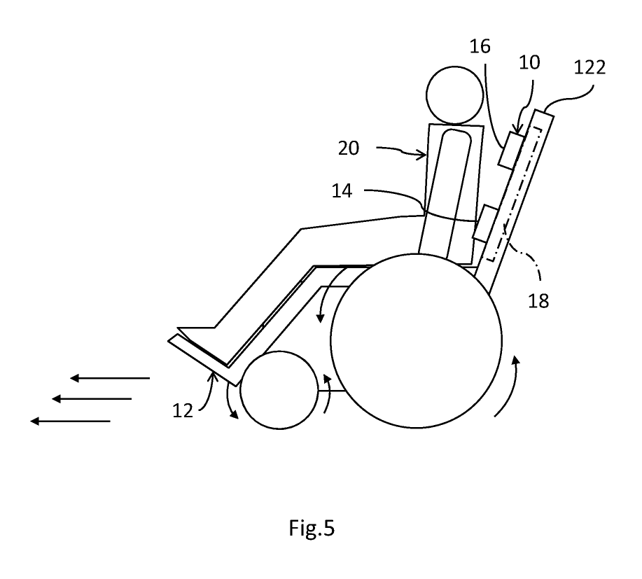

Then, refer to FIG. 2 and FIG. 3. The wheelchair 12 equipped with the wheelchair control system 10 is provided to a sitter 20 for sitting. Refer to FIG. 4a and FIG. 4b. When the first sensor 14 and the second sensor 16 are simultaneously triggered or non-triggered by the back of the sitter 20, the control device 18 controls the wheelchair 12 to stop. Refer to FIG. 5. When the first sensor 14 is triggered by the back of the sitter 20, the control device 18 controls the wheelchair 12 to operate. For example, the control device 18 controls the wheelchair 12 to move forward.

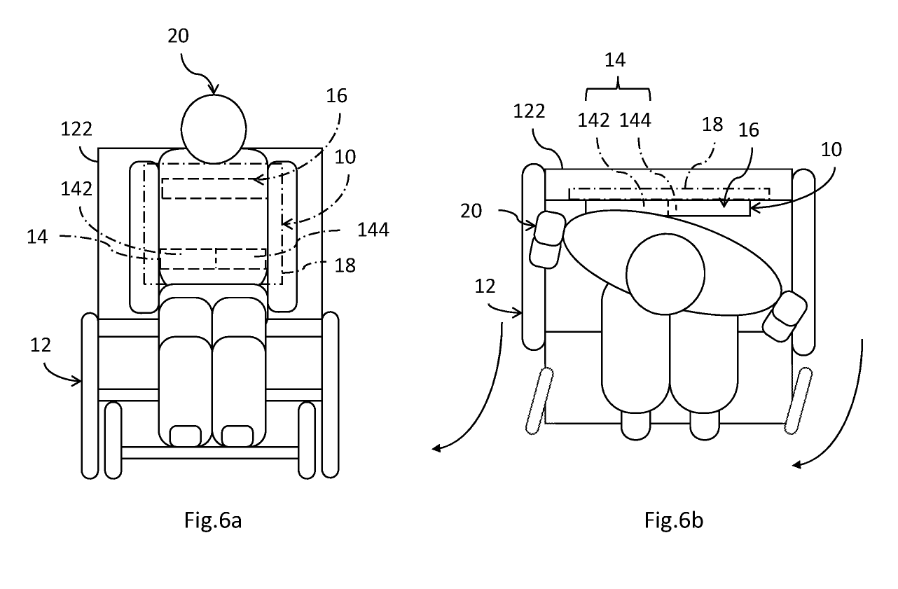

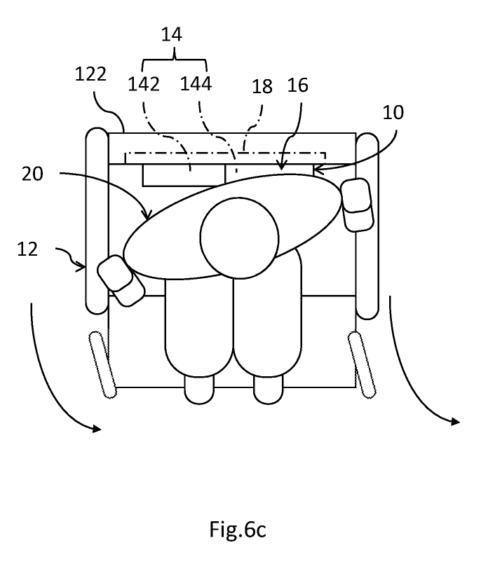

In addition to the abovementioned operation, refer to FIG. 6a, the first sensor 14 further comprises at least two sensing elements, such as two sensing elements 142 and 144 whose shape, amount and arrangement are not limited and changed according to the requirement of manufacturers. When the sitter 20 sits in the wheelchair 12 and the back of the sitter 20 touches the sensing element 142 or the sensing 144 of the first sensor 14, the wheelchair 12 moves in front-left or front-right directions. Take FIG. 6b for example. The wheelchair 12 moves in a right direction for the sitter 20 when the back of the sitter 20 touches and triggers the sensing element 142 of the first sensor 14. Refer to FIG. 6c. The wheelchair 12 moves in a left direction for the sitter 20 when the back of the sitter 20 touches and triggers the sensing element 144 of the first sensor 14.

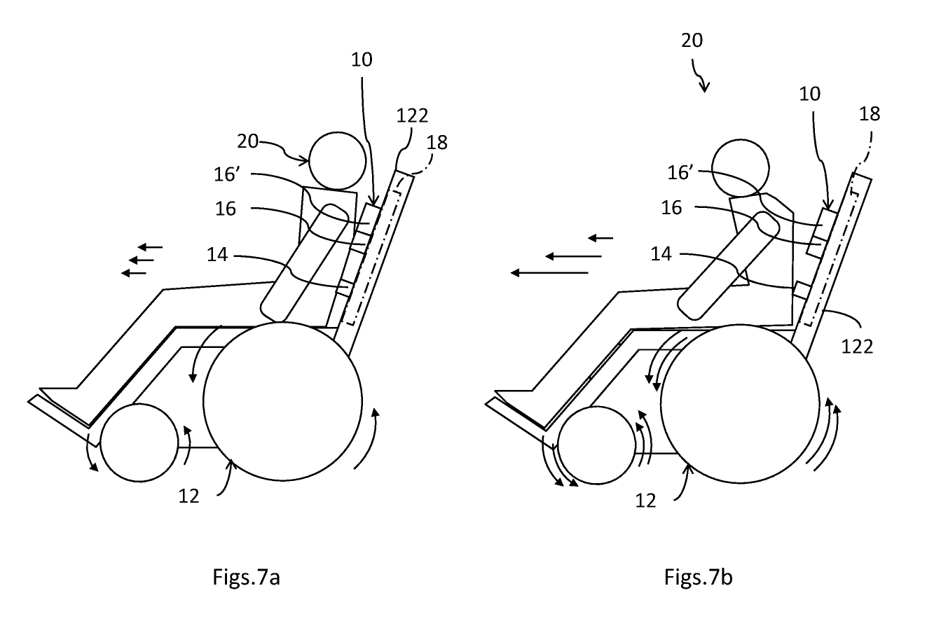

Refer to FIG. 7a and FIG. 7b. The amount of the second sensor 16 is two or more. For example, the second sensors 16 and 16′ from bottom to top are used. The second sensors 16 and 16′ from bottom to top are arranged on the back 122 of the wheelchair 12. The second sensor 16 is arranged under the second sensor 16′. When the sitter 20 sits in the wheelchair 12, and the back of the sitter 20 touches the first sensor 14 and does not sequentially touch the second sensors 16 and 16′, the wheelchair 12 moves at different speed. Refer to FIG. 7a. When the back of the sitter 20 touches and triggers the first sensor 14 and the second sensor 16, and separates from the second sensor 16′, the wheelchair 12 slowly moves forward. Then, refer to FIG. 7b. The wheelchair 12 fast moves forward when the sitter 20 separates from the second sensor 16′. In addition to the second sensor 16′ controlling speed, the first sensor 14 is divided into two first sensing elements 142 and 144 to control the wheelchair 12 to turn left or right, as shown in FIG. 6a. The detailed control method has been described in previous paragraph so will not be reiterated.

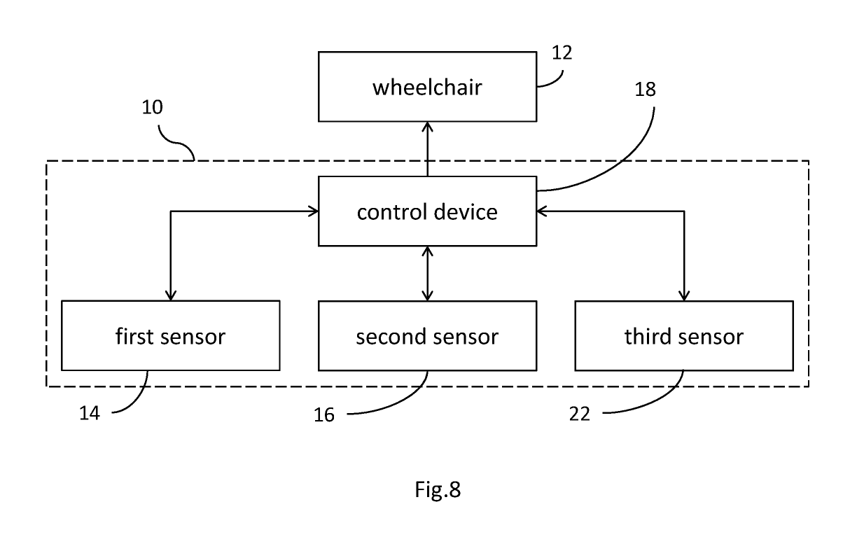

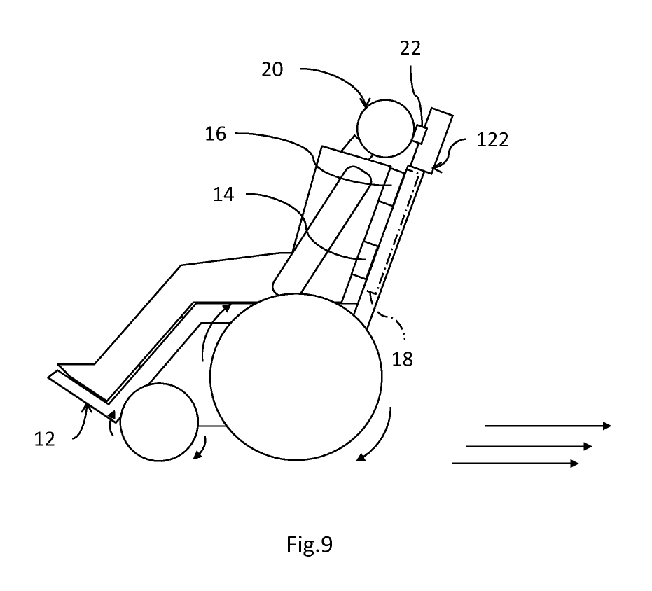

After explaining that the wheelchair moves forward, turns front-left, turns front-right, and moves at different speed, some wheelchairs can continuously turn left or right to move to a position in back of the original position, and then move forward whereby the wheelchair moves backward. In addition to the abovementioned way, the present invention can control the wheelchair to directly move backward. Then, how the present invention directly moves backward is described. Refer to FIG. 8 and FIG. 9. In addition to the first sensor 14 and the second sensor 16, the present invention further comprises a third sensor 22 arranged on the back 122 of the wheelchair 12 and above the second sensor 16 and electrically connected with the control device 18. When the first sensor 14, the second sensor 16 and the third sensor 22 are touched and triggered by the back of the sitter 20, the control device 18 controls the wheelchair 12 to move backward. In the embodiment, the first sensor 14, the second sensor 16 and the third sensor 22 are all inductive switches. The inductive switches are micro-switches or touch switches. In the embodiment, the inductive switches are touch switches. Although the first sensor 14, the second sensor 16 and the third sensor 22 shown in FIG. 8 and FIG. 9 are used to control the wheelchair 12 to move backward, the first sensor 14 is divided into two first sensing elements (not shown) to control the wheelchair 12 to move leftward or rightward. In addition to one second sensor 16, one or more second sensors 16 are added to control the speed, whereby the wheelchair 12 stops, moves forward, backward, leftward and rightward, and accelerates.

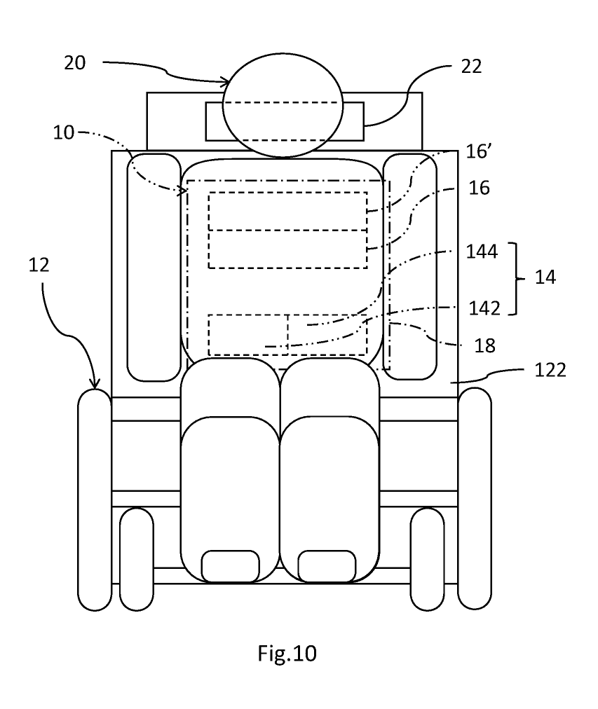

After explaining the ways of moving forward and backward, accelerating, and turning left and right, the present invention explain the wheelchair control system performing the abovementioned various operation in an embodiment in detail. Refer to FIG. 10. A wheelchair control system 10 is arranged on the back 122 of a wheelchair 12. The wheelchair control system 10 comprises a first sensor 14 and at least one second sensor. For example, the second sensors 16 and 16′ are used. The wheelchair control system 10 further comprises a third sensor 22 and a control device 18. The first sensor 14, the second sensors 16 and 16′ and the third sensor 22 are all arranged on the back 122 of the wheelchair 12. The second sensors 16 and 16′ are arranged above the first sensor 14. The second sensor 16′ is arranged above the second sensors 16. The control device 18 is arranged in the back 122 of the wheelchair 12 and electrically connected with the first sensor 14, the second sensors 16 and 16′ and the third sensor 22. The position of the control device 18 of the present invention is not limited and changed according to the requirement of manufacturers. Besides, the wheelchair 12 stops when the sitter 20 sits in the wheelchair 12 and the back of the sitter 20 triggers or non-triggers the first sensor 14 and the second sensors 16 and 16′. The wheelchair 12 gradually accelerates when gradually separating from the second sensors 16 and 16′. For example, the wheelchair 12 slowly moves forward when separating from the second sensor 16′. Then, the wheelchair 12 fast moves forward when separating from the second sensors 16 and 16′ to trigger the first sensor 14. The wheelchair 12 moves in front-left or front-right directions by triggering the first sensing elements 142 and 144 of the first sensor 14. When the sitter 20 wants to move backward, the sitter 20 triggers the first sensor 14 and the second sensors 16 and 16′ to stop the wheelchair 12, and then triggers the first sensor 14, the second sensors 16 and 16′ and the third sensor 22 to control the wheelchair 12 to move backward.

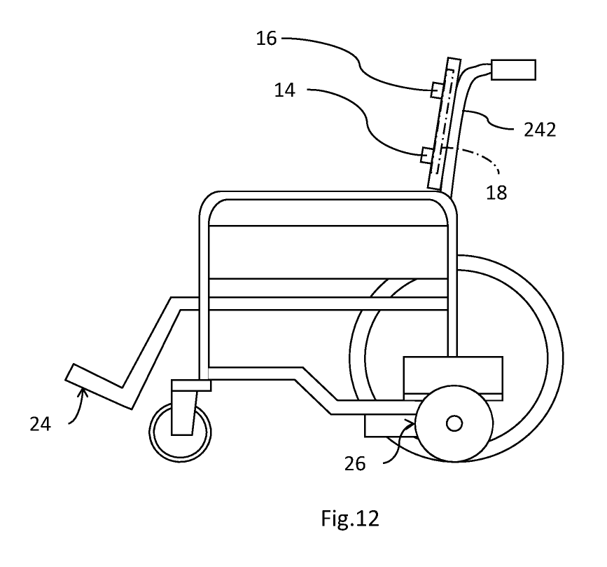

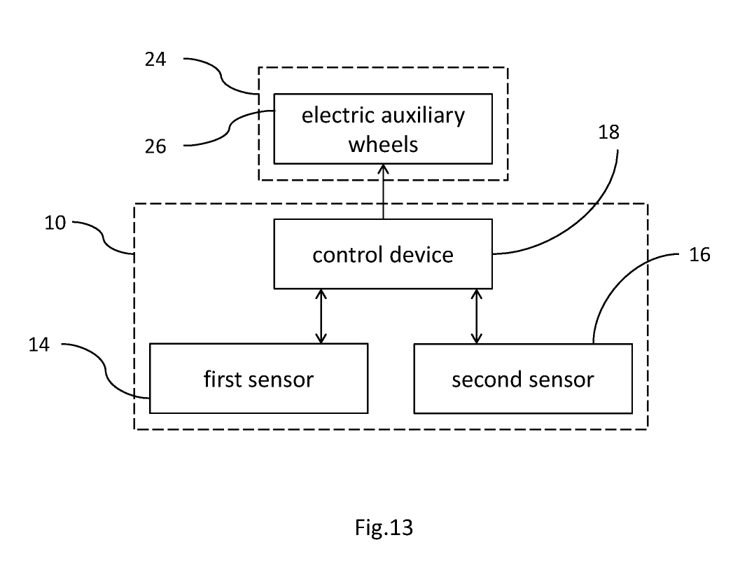

In the abovementioned embodiment, the wheelchair is an electric wheelchair. However, the wheelchair of the present invention is an electric and manual wheelchair or a manual wheelchair. The control device is installed in a body of the wheelchair, and the position of the control device depends on the sitter. Wherein, the first sensor, at least one second sensor and the third sensor are arranged in the back of the wheelchair. Then, another embodiment is provided. Refer to FIG. 12 and FIG. 13. When the wheelchair is the conventional manual wheelchair 24, the manual wheelchair 24 is provided with electric auxiliary wheels 26 electrically connected with the control device 18. The control device 18 controls the electric auxiliary wheels 26 to move the manual wheelchair 24. For example, the first sensor 14 and at least one second sensor 16 are arranged on the back 242 of the manual wheelchair 24. For example, in this embodiment, one second sensor 16 is arranged, but the present invention is not limited thereto. The first sensor 14 and the second sensor 16 are electrically connected with the control device 18. The first sensor 14, the second sensor 16 and the control device 18 are integrated together, and then arranged on the back 242 of the manual wheelchair 24. The ways of triggering the first sensor 14 and the second sensor 16 are the same to the abovementioned ways. The control device 18 controls the electric auxiliary wheels 26 to move the manual wheelchair 24. The paragraph explains that the present invention is also installed on the manual wheelchair 24. Although the third sensor is not disclosed in the paragraph, the present invention is not so limited. More second sensors 16 and the third sensor are added in the manual wheelchair 24 according to the requirement of manufacturers.

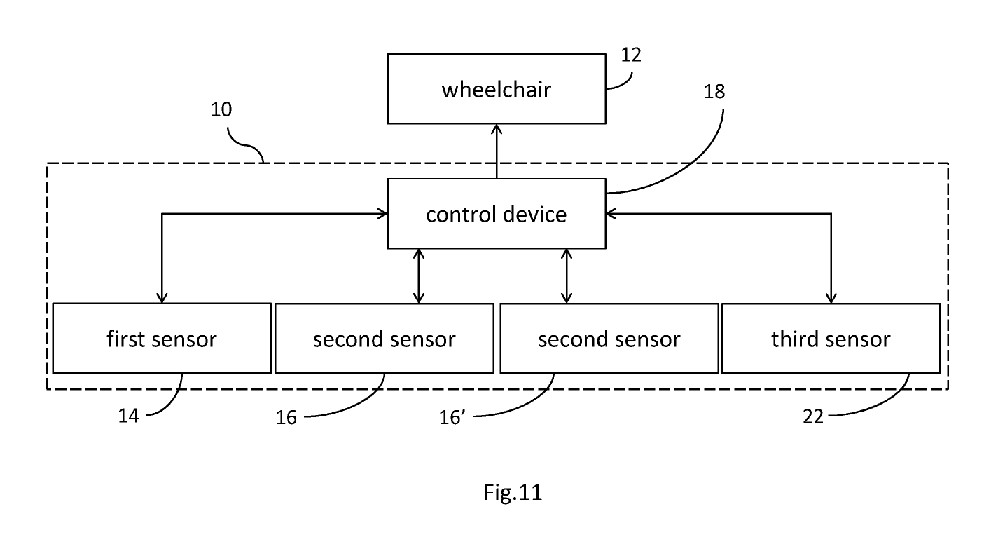

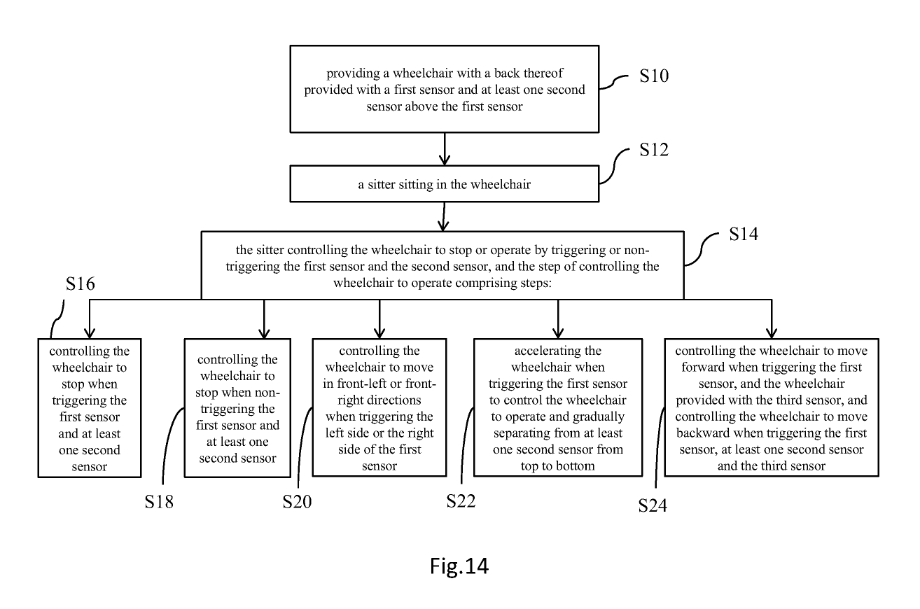

Refer to FIG. 14, FIG. 11 and FIG. 10 to explain the wheelchair control method of the present invention after explaining the different operation, connection relation and positions of the elements of the wheelchair control system of the present invention. Firstly, in Step S10, a wheelchair 12 is provided. A first sensor 14 and at least one second sensor are arranged on the back 122 of the wheelchair 12. For example, the second sensors 16 and 16′ are used. The second sensors 16 and 16′ are arranged above the first sensor 14. In the embodiment, at least one second is used. The second sensors 16 and 16′ are exemplified here. The amount of the second sensors is not limited. The second sensor 16′ is arranged above the second sensor 16. Then, in Step S12, the sitter 20 sits in the wheelchair 12. Afterwards, in Step S14, the sitter 20 triggers or non-triggers the first sensor 14 and the second sensors 16 and 16′ to control the wheelchair 12 to stop or operate. The step of controlling the wheelchair 12 to stop or operate comprising steps: As shown in Step S16, the control device 18 controls the wheelchair 12 to stop when the back of the sitter 20 touches and triggers the first sensor 14 and the second sensors 16 and 16′. As shown in Step S18, the control device 18 controls the wheelchair 12 to stop when the back of the sitter 20 non-triggers the first sensor 14 and the second sensors 16 and 16′. As shown in Step S20, the sitter 20 triggers the first sensor 14 whereby the wheelchair 12 operates. The left side or the right side of the first sensor 14 is triggered whereby the wheelchair 12 moves in front-left or front-right directions for the sitter 20. For example, the first sensing element 142 at the left side of the first sensor 14 is triggered whereby the wheelchair 12 moves in a front-right direction for the sitter 20. Alternatively, the first sensing element 144 at the right side of the first sensor 14 is triggered whereby the wheelchair 12 moves in a front-left direction for the sitter 20. As shown in Step S22, the wheelchair 12 gradually accelerates when the sitter 20 triggers the first sensor 14 to move the wheelchair 12 and gradually separates from the second sensors 16 and 16′ from top to bottom. For example, the wheelchair 12 slowly moves forward when the sitter 20 triggers the first sensor 14 and the second sensor 16 and separates from the second sensor 16′. Then, the wheelchair 12 fast moves forward when the sitter 20 separates from the second sensor 16. As shown in Step S24, the wheelchair 12 moves forward when the sitter 20 triggers the first sensor 14. The wheelchair 12 moves backward when the third sensor 22 is arranged on the back 122 of the wheelchair 12 and the sitter 20 triggers the first sensor 14, the third sensor 22 and the second sensors 16 and 16′.

In conclusion, the present invention not only provides a wheelchair control system but also uses the wheelchair control system to provide a more convenient and easily-operated control method to a sitter. The abovementioned control method should be not limited. The amount of the abovementioned second sensor is changed according to the requirement of the sitter, such as adding three, five or more second sensors to more precisely control acceleration. The main spirit of the present invention is to use the back of the user to control the move of the wheelchair. Later on, the design of the sensors with different amount to control switches is related to the present invention. Regardless of whether upper limbs of the sitter inconveniently controls the wheelchair, the sitter controls the wheelchair to move forward, backward, leftward or rightward or controls the speed of the wheelchair according to how the sitter himself/herself wants the wheelchair to move. Moving the upper body of the sitter controls the wheelchair to move, which quite meets ergonomics. Although the shape of the sensors of the present invention is not limited, the sensors are designed to correspond to the waist of the sitter, thereby forming more comfortable shapes meeting the backs of human bodies. The present invention provides a special back operation method different from the operation of the conventional wheelchair or the electric wheelchair.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A wheelchair control system arranged on a back of a wheelchair, and said wheelchair control system comprising:
a first sensor arranged on said back of said wheelchair;
at least one second sensor arranged on said back of said wheelchair and above said first sensor; and
a control device electrically connected with said first sensor and said at least one second sensor and controlling said wheelchair to stop or operate according as said first sensor and said at least one second sensor are triggered or non-triggered.

2. The wheelchair control system of claim 1, wherein when said first sensor and said at least one second sensor are both triggered or non-triggered, said control device controls said wheelchair to stop.

3. The wheelchair control system of claim 1, wherein said first sensor further comprises at least two first sensing elements, and when one said first sensing element is triggered, said wheelchair moves in front-left or front-right directions.

4. The wheelchair control system of claim 1, wherein said at least one second sensor is two or more second sensors, and said at least two second sensors are arranged on said back of said wheelchair from bottom to top, and when said first sensor is triggered and said at least two second sensors are sequentially non-triggered, said wheelchair moves at different speed.

5. The wheelchair control system of claim 1, wherein when only said first sensor is triggered, said control device controls said wheelchair to move forward.

6. The wheelchair control system of claim 5, further comprising a third sensor arranged on said back of said wheelchair and above said at least one second sensor and electrically connected with said control device, and when said first sensor, said second sensor and said third sensor are all triggered, said control device controls said wheelchair to move backward.

7. The wheelchair control system of claim 6, wherein said first sensor, said at least one second sensor and said third sensor are all inductive switches.

8. The wheelchair control system of claim 7, wherein said inductive switches are micro-switches or touch switches.

9. The wheelchair control system of claim 6, wherein when a sitter sits in said wheelchair, said a back of said sitter triggers said first sensor, said second sensor and said third sensor.

10. The wheelchair control system of claim 1, wherein said wheelchair is an electric wheelchair or an electric and manual wheelchair.

11. The wheelchair control system of claim 1, wherein said wheelchair is a manual wheelchair, and said manual wheelchair is provided with electric auxiliary wheels electrically connected with said control device, and said control device controls said electric auxiliary wheels to move said manual wheelchair.

12. A wheelchair control method comprising steps of:
providing a wheelchair with a back thereof provided with a first sensor and at least one second sensor arranged above said first sensor;
a sitter sitting in said wheelchair; and
said sitter controlling said wheelchair to stop or operate according as said first sensor and said at least one second sensor are triggered or non-triggered.

13. The wheelchair control method of claim 12, wherein said first sensor and said at least one second sensor are both triggered whereby said wheelchair stops.

14. The wheelchair control method of claim 12, wherein said first sensor and said at least one second sensor are both non-triggered whereby said wheelchair stops.

15. The wheelchair control method of claim 12, wherein when said first sensor is triggered whereby said wheelchair operates, a right side or a left side of said first sensor is triggered whereby said wheelchair moves in front-left or front-right directions.

16. The wheelchair control method of claim 12, wherein when said first sensor is triggered whereby said wheelchair operates, gradually separating from said at least one second sensor from top to bottom gradually increases speed of moving said wheelchair.

17. The wheelchair control method of claim 12, wherein said first sensor is triggered whereby said wheelchair moves forward.

18. The wheelchair control method of claim 17, wherein said back of said wheelchair is provided with a third sensor arranged above said at least one second sensor, and said first sensor, said at least one second sensor and said third sensor are all triggered whereby said wheelchair moves backward.

19. The wheelchair control method of claim 18, wherein said first sensor, said at least one second sensor and said third sensor are all inductive switches.

20. The wheelchair control method of claim 19, wherein said inductive switches are micro-switches or touch switches.

21. The wheelchair control method of claim 12, wherein said first sensor and said at least one second sensor are electrically connected with a control device, and said sitter triggers said first sensor and said at least one second sensor whereby said control device controls said wheelchair to operate.
